(19) United States
(12) Patent Application Publication
(10) Pub. No.: US 2007/0002199 A1
(43) Pub. Date: Jan. 4, 2007

(54) Liquid crystal display device and method for manufacturing the same

(75) Inventors: Saishi Fujikawa, Atsugi (JP); Kunio Hosoya, Atsugi (JP)

Correspondence Address: NIXON PEABODY, LLP, 401 9TH STREET, NW, SUITE 900, WASHINGTON, DC, 20004-2128, US

(73) Assignee: Semiconductor Energy Laboratory Co., Ltd., Atsugi-shi (JP)

(21) Appl. No.: 11/450,359

(22) Filed: Jun. 12, 2006

(30) Foreign Application Priority Data
Jun. 30, 2005 (JP) 2005-191078

(51) Int. Cl. G02F 1/136

(52) U.S. Cl. 349/43

(57) ABSTRACT

In the present invention, it is an object to provide a liquid crystal display device in which a precise position alignment in attaching an active matrix substrate and a counter substrate is unnecessary and also does not affect an application of an electric field to a liquid crystal from an electrode, and a manufacturing method thereof. According to one feature of the present invention, the liquid crystal display device is formed using an active matrix substrate in which a driver circuit including a plurality of TFTs, a wiring, and the like, a pixel portion including a plurality of TFTs, a wiring, a pixel electrode, and the like are formed over a substrate provided with a light-shielding film and a coloring film, and the liquid crystal display device has a structure in which a liquid crystal is injected between the active matrix substrate and the counter substrate.

### BACKGROUND OF THE INVENTION

1. Field of the Invention

The present invention relates to an active matrix liquid crystal display device and a method for manufacturing the same.

2. Description of the Related Art

An active matrix liquid crystal display device using an active element such as a thin film transistor (TFT) has been conventionally known. An active matrix liquid crystal display device can increase pixel density, is small and lightweight, and also consumes low power; therefore, a product such as a monitor of a personal computer, a liquid crystal TV, or a monitor of a car navigation system has been developed as one of flat panel displays which is a substitute for CRT.

As for a liquid crystal display device, a substrate (active matrix substrate) over which a driver circuit constituted by a plurality of TFTs and wirings (such as a source signal line driver circuit or a gate signal line driver circuit), a pixel portion, and the like constituted by a plurality of TFTs, wirings, and a pixel electrode (individual electrode) are formed and a substrate (counter substrate) over which a counter electrode (common electrode), a light-shielding film, a coloring film (color filter), and the like are formed are attached to each other, a liquid crystal is injected therebetween, and liquid crystal molecules are aligned by an electric field which is applied between the pixel electrode and the counter electrode.

However, when an active matrix substrate and a counter substrate are attached to each other, it is necessary to align the position precisely. There has been a problem that displacement between a pixel electrode over an active matrix substrate and a coloring film over a counter substrate occurs and a color shift or a blur occurs in an image in displaying if the alignment is not performed sufficiently.

Correspondingly, a liquid crystal display device is reported, in which by forming a coloring film which has been formed over a counter substrate over a pixel electrode of an active matrix substrate, uniform and bright display without color bleeding can be obtained and a precise position alignment in attaching both of the substrates is unnecessary (for example, see Patent Document 1).

[Patent Document 1] Japanese Patent Laid-Open No. 2001-175198

### SUMMARY OF THE INVENTION

However, when a structure is used, in which a coloring film is formed over a pixel electrode like the liquid crystal display device of the above-described document, a structure in which a dielectric is interposed between the pixel electrode and a liquid crystal is obtained; therefore, a problem occurs, in which an electric field which is applied to the liquid crystal from an electrode is disturbed. It is an object of the present invention to provide a liquid crystal display device which does not need a precise position alignment in attaching an active matrix substrate and a counter substrate and does not affect an application of an electric field to a liquid crystal from an electrode, and a method for manufacturing the same.

According to one feature of the present invention, a liquid crystal display device of the present invention is formed by using an active matrix substrate in which a plurality of TFTs, wirings, a pixel portion and the like constituted by a pixel electrode or the like are integrated over a substrate provided with a light-shielding film and a coloring film, and the liquid crystal display device has a structure in which a liquid crystal is injected between such an active matrix substrate and a counter substrate.

Also, a structure can be employed in the present invention, in which a counter electrode (common electrode) is formed at a counter substrate side; however, by employing a structure in which a counter electrode (common electrode) is included in a pixel portion of an active matrix substrate, the present invention can be carried out even in a case of an In-Plain Switching system such as an In-Plain Switching (IPS) mode or a Fringe Field Switching (FFS) mode. Note that, although an insulating substrate over which nothing is formed is used as the counter substrate in this case, it is preferable to form an alignment film over a surface which is in contact with a liquid crystal in the counter substrate.

In addition, as for an active matrix substrate of the present invention, a TFT is formed over a substrate provided with a light-shielding film and a coloring film; therefore, it is preferable to form a barrier film over the light-shielding film and the coloring film in order to prevent the TFT from being contaminated by an organic material or the like which is used for forming the coloring film and the light-shielding film. Note that a silicon nitride film, a silicon nitride oxide film, or the like can be used as the barrier film.

Moreover, as for an active matrix substrate of the present invention, a TFT is formed over a substrate provided with a light-shielding film and a coloring film; therefore, it is preferable to form the TFT in a low-temperature process (temperature of a manufacturing process is 200 to 400° C. or less) in consideration of effect of temperature in a manufacturing process of a TFT with respect to a coloring film formed from an organic material. Further, as a TFT which can be formed in a low-temperature process, the following can be given: a TFT or the like using an amorphous semiconductor containing silicon, silicon germanium (SiGe) or the like as its main component in an active layer and using a semiamorphous semiconductor (hereinafter, referred to as SAS) which is a film including semiconductor having an intermediate structure between amorphous semicodncutor and semiconductor having a crystalline structure (including single crystal and poly crystal) in the active layer. Note that a semiconductor of a crystalline structure (polycrystalline semiconductor) may be used as the TFT.

In a liquid crystal display device of the present invention, a transmissive liquid crystal display device can be obtained, in which a light source is provided at a counter substrate side and light is transmitted to an active matrix side; however, not only the transmissive liquid crystal display device in which light is transmitted to the counter substrate side but also a reflective liquid crystal display device in which light is transmitted to an active matrix substrate side can be obtained in a case of providing a light source at the active matrix substrate side. Note that it is necessary to provide a reflective electrode over the counter substrate in the case of a reflective liquid crystal display device.

In a case where a TFT which is formed over the active matrix substrate is a bottom gate TFT having an active layer including amorphous semiconductor semiamorphous semiconductor, or polycrystalline semiconductor as described above, and also a case where a light source is provided at a counter electrode side, it is preferable to provide a light-shielding body at a position which is overlapped with the active layer in order to prevent the active layer of the TFT from being irradiated with light from the light source. In a case of proving a light-shielding body, the light-shielding body is formed at a position which is overlapped with a gate electrode at the same time as a source electrode and a drain electrode of the TFT by forming a bottom gate TFT in a channel stop (protection) type.

Furthermore, in the present invention, in a case where a pixel electrode (individual electrode) and a counter electrode (common electrode) are formed in a pixel portion of an active matrix substrate as described above, it is preferable that one or both of the pixel electrode (individual electrode) and the counter electrode (common electrode) is/are formed of a transparent conductive film.

According to one feature of the present invention, a specific structure of the present invention is a liquid crystal display device having a coloring film formed over a substrate and an electrode formed over the coloring film by having an insulating film therebetween, and the electrode is formed at a position which is overlapped with the coloring film by having the insulating film therebetween.

A structure in which a thin film transistor formed over the insulating film and an electrode (pixel electrode) are electrically connected to each other is also included in the above-described structure.

Moreover, according to another feature of the present invention, a structure having a thin film transistor, a pixel electrode electrically connected to the thin film transistor, and a common electrode over an insulating film, and also a structure in which the pixel electrode and the common electrode are formed at a position which is overlapped with a coloring film are included. Furthermore, a structure in which one or both of the pixel electrode and the common electrode is/are formed of a transparent conductive film is also included.

As a thin film transistor which can be used in the present invention, a thin film transistor having a gate electrode, a gate insulating film, a first semiconductor film, a source region, a drain region, a source electrode, and a drain electrode can be used, where the first semiconductor film can be formed of an amorphous semiconductor containing silicon or silicon germanium as its main component, a semiamorphous semiconductor in which an amorphous state and a crystalline state are mixed, or a semiconductor having a crystalline structure (polycrystalline semiconductor).

According to another feature of the present invention, in a case where a thin film transistor used in the present invention is a bottom gate thin film transistor, a first semiconductor film which forms a channel formation region is formed over a gate electrode by having a gate insulating film therebetween, and a conductive film (so-called light-shielding body) which is the same as a conductive film which forms a source electrode and a drain electrode is formed at a position which is over the first semiconductor film and also overlapped with the gate electrode. Furthermore, in order to form the above-described light-shielding body, an insulator is formed at a position which is over the first semiconductor film and also overlapped with the gate electrode.

According to another feature of the present invention, in the above structure, the thickness of the insulator is thicker than that of the source electrode and the drain electrode, and furthermore, by narrowing the width of the insulator than that of the gate electrode, the width of the conductive film (light-shielding body) provided at a position which is over the insulator and also overlapped with the gate electrode can be narrowed than that of the gate electrode.

In addition, according to another feature of the present invention, in the above structure, the light-shielding body is electrically connected to the gate electrode through an auxiliary wiring, and the auxiliary wiring is formed using the same material as the pixel electrode.

Moreover, according to another feature of the present invention, another structure of the present invention is a method for manufacturing a liquid crystal display device having steps of forming a coloring film over a substrate; forming an insulating film over the coloring film; forming a thin film transistor including a gate electrode, a gate insulating film, a channel formation region, a source region, a drain region, a source electrode, and a drain electrode over the insulating film; and forming an electrode which is electrically connected to the drain electrode at a position which is overlapped with the coloring film.

In the above structure, the channel formation region can be formed using an amorphous semiconductor containing silicon or silicon germanium as its main component, a semiamorphous semiconductor in which an amorphous state and a crystalline state are mixed, or a semiconductor having a crystalline structure (polycrystalline semiconductor).

According to another feature of the present invention, in the above structure, in a case where a bottom gate thin film transistor is formed, a gate electrode formed of a first conductive film is formed over an insulating film; a gate insulating film is formed over the gate electrode; a first semiconductor film is formed over the gate insulating film; an insulator is formed at a position which is a part over the first semiconductor film and overlapped with the gate electrode; a source region and a drain region formed of a second semiconductor film which is separated by the insulator to be formed are formed over the first semiconductor film; a source electrode and a drain electrode formed of a second conductive film which is separated by the insulator to be formed are formed over the second semiconductor film; and an electrode (pixel electrode) which is electrically connected to the drain electrode is formed at a position which is overlapped with the coloring film.

According to another feature of the present invention, in the above structure, a light-shielding body formed of the second conductive film is formed over the insulator.

According to another feature of the present invention, in the above structure, in a case where a common electrode is formed concurrently with the gate electrode, the common electrode and the pixel electrode are formed at a position which is overlapped with the coloring film. Furthermore, a structure in which one or both of the pixel electrode and the common electrode is/are formed of a transparent conductive film is also included.

According to another feature of the present invention, in the above structure, the light-shielding body is electrically connected to the gate electrode through an auxiliary wiring, and the auxiliary wiring is formed using the same material as the pixel electrode.

In a liquid crystal display device of the present invention, as for an active matrix substrate which is one of a pair of substrates to which a liquid crystal is injected, a driver circuit constituted by a plurality of TFTs, wirings, and the like and a pixel portion or the like constituted by a plurality of TFTs, wirings, a pixel electrode, and the like are integrated over a substrate provided with a light-shielding film and a coloring film; accordingly, the position between the coloring film and the pixel portion is aligned in the active matrix substrate. Therefore, a precise position alignment which has been conventionally required in attaching is unnecessary.

The coloring film of the active matrix substrate is provided at the opposite side from a liquid crystal with respect to the pixel electrode; therefore, the coloring film can be formed in the active matrix substrate without affecting an application of an electric field with respect to the liquid crystal from both of the electrodes.

In the present invention, in a case where a TFT which is formed in an active matrix substrate is a bottom gate TFT having an active layer formed from an amorphous semiconductor, a semiamorphous semiconductor, or a polycrystalline semiconductor and also a case where a light source is provided at a counter substrate side, when a light-shielding body is provided at a position which is overlapped with the active layer, a leak current can be prevented from being generated between a source region and a drain region in a case of driving the TFT as well as the above effect. Further, in a case of providing the light-shielding body, by forming the bottom gate TFT as a channel stop (protection) type, the light-shielding body can be provided without increasing the number of processes.

In addition, in the present invention, in a case where a pixel electrode (individual electrode) and a counter electrode (common electrode) are formed in a pixel portion of an active matrix substrate, by forming one or both of the electrodes by using a transparent conductive film, an aperture ratio can be prevented from decreasing as well as the above effect. Note that a top gate TFT may be used as the TFT of the present invention, although the bottom gate TFT is shown.

### BRIEF DESCRIPTION OF THE DRAWINGS

In the accompanying drawings:

FIG. 1 is a view explaining a liquid crystal display panel of the present invention;

FIGS. 2A to 2E are views explaining a method for manufacturing an active matrix substrate;

FIGS. 3A to 3D are views explaining a method for manufacturing an active matrix substrate;

FIG. 4 is a plan view of an active matrix substrate;

FIG. 5 is a view explaining a liquid crystal display panel of the present invention;

FIGS. 6A and 6B are a plan view and a cross-sectional view of an active matrix substrate;

FIGS. 7A and 7B are a plan view and a cross-sectional view of an active matrix substrate;

FIGS. 8A to 8C are views explaining a coloring film;

FIGS. 9A and 9B are views explaining a liquid crystal display panel of the present invention;

FIGS. 10A to 10C are views explaining a driver circuit of a liquid crystal display panel of the present invention;

FIG. 11 is a view explaining a liquid crystal display device; and

FIGS. 12A to 12E are views explaining electronic devices.

### DETAILED DESCRIPTION OF THE INVENTION

Hereinafter, one mode of the present invention will be explained in detail with reference to the drawings or the like. However, the present invention can be carried out in many different modes, and it is easily understood by those skilled in the art that the modes and details can be modified in various ways without departing from the purpose and the scope of the present invention. Therefore, the present invention is not understood as being limited to the description of the embodiment modes.

### Embodiment Mode 1

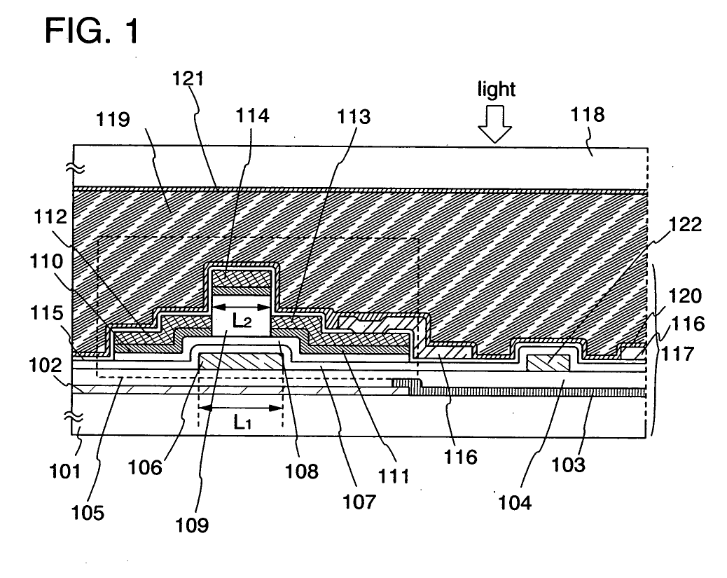

In Embodiment Mode 1, among liquid crystal panels that can be used for a liquid crystal display device of the present invention, a liquid crystal display panel which is driven by an In-Plain Switching system (such as an IPS mode or an FFS mode), in which a pixel electrode (individual electrode) and a counter electrode (common electrode) are formed in an active matrix substrate, will be explained with reference to FIG. 1.

In FIG. 1, a light-shielding film 102 is formed over a substrate 101, and a coloring film 103 is formed so as to be overlapped with part of the light-shielding film 102.

A glass substrate, a quartz substrate, a substrate formed from an insulating substance such as ceramic such as alumina, a plastic substrate, a silicon wafer, a metal plate, or the like can be used for the substrate 101.

The light-shielding film 102 is patterned to be formed so as to cover all of the periphery of each pixel in a pixel portion or part thereof. As a material used for the light-shielding film 102, specifically, a metal material such as chromium or chromium oxide can be used in addition to an insulating film (such as polyimide or an acrylic resin) containing a color pigment or a colorant, resin BM, carbon black, and a resist. Also, the thickness of the light-shielding film 102 is preferably 1 to 3 μm.

The coloring film 103 is formed so that part thereof is overlapped with the light-shielding film. Note that the coloring film 103 may be formed from a material which shows a different color (for example, three colors of red, green, and blue) every one pixel column in the pixel portion. Alternatively, the coloring film 103 may be formed from a material which shows a different color (for example, three colors of red, green, and blue) every one pixel. Furthermore, the coloring film 103 may be formed from a material in which all pixels show the same color. As a material used for the coloring film 103, specifically, a photosensitive resin, a resist, or the like can be used in addition to an insulating film (such as polyimide or an acrylic resin) containing a color pigment. Also, the thickness of the coloring film 103 is preferably 1 to 3 μm. Note that the coloring film 103 of the present invention may formed so as to cover an end of the light-shielding film 102, and therefore, the margin in manufacturing a liquid crystal display device can be set large and the liquid crystal display device can be easily manufactured.

A planarizing film 104 for reducing concavity and convexity that are generated by forming the light-shielding film 102 and the coloring film 103 is formed over the light-shielding film 102 and the coloring film 103. The planarizing film 104 can be formed by using an insulating material (such as an organic material and an inorganic material) and can be formed with a single layer or a stacked layer. Note that, specifically, the planarizing film 104 can be formed using acrylic acid, methacrylic acid, and a derivative thereof; a heat-resistant high molecular compound such as polyimide, aromatic polyamide, polybenzimidazole, or an epoxy resin; a film made of an inorganic siloxane polymer based organic insulating material including a Si—O—Si bond of compounds containing silicon, oxygen, or hydrogen formed using a siloxane polymer based material as a starting material, which is typified by silica glass; a film made of an organic siloxane polymer based organic insulating material in which hydrogen bonded to silicon typified by alkylsiloxane polymer, alkylsilsesquioxane polymer, hydrogenated silsesquinoxane polymer, or hydrogenated alkylsilsesquioxane polymer is substituted by an organic group such as methyl or phenyl; a silicon oxide film; a silicon nitride film; a silicon oxynitride film; a silicon nitride oxide film; or other films made of an inorganic insulating material containing silicon. In addition, the thickness of the planaziring film 104 is preferably 1 to 3 μm.

Although not shown here, a blocking film such as a silicon nitride film or a silicon nitride oxide film may be formed over the planarizing film 104 in order to prevent an impurity from being mixed into a semiconductor film from the substrate 101 or the planarizing film 104.

A gate electrode 106 of a TFT 105 and a common electrode 122 are formed over the planarizing film 104. A film such as a film made of a metal element such as Ag, Au, Cu, Ni, Pt, Pd, Ir, Rh, W, Al, Ta, Mo, Cd, Zn, Fe, Ti, Zr, Ba, or Nd; a film made of an alloy material containing the above-described element as its main component; a film made of an alloy material containing an element such as Si or Ge; a film in which Mo, Al, and Mo are stacked; a film in which Ti, Al, and Ti are stacked; a film in which MoN, Al—Nd, and MoN are stacked; a film in which Mo, Al—Nd, and Mo are stacked; a film in which Al and Cr are stacked; a film made of a compound material such as metal nitride; a film of indium tin oxide (ITO) which is used as a transparent conductive film, IZO (indium zinc oxide) in which 2 to 20% of zinc oxide (ZnO) is mixed into indium oxide, ITO having silicon oxide as a composition, or the like can be used for the gate electrode 106 and the common electrode 122. In addition, the thickness of each of the gate electrode 106 and the common electrode 122 is preferably 200 nm or more, and more preferably, 300 to 500 nm.

An insulating film is formed over the gate electrode 106 and the common electrode 122, and part thereof is a gate insulating film 107 of the TFT 105. The insulating film (including the gate insulating film 107) is formed with a single layer or a stacked layer using a silicon oxide film, a silicon nitride film, a silicon oxynitride film, a silicon nitride oxide film, or other insulating films containing silicon. Note that the thickness of the gate insulating film 107 is preferably 10 to 150 nm, and more preferably, 30 to 70 nm.

A first semiconductor film 108 is formed over the insulating film including the gate insulating film 107 as part thereof. A film having any state selected from an amorphous semiconductor containing silicon, silicon germanium (SiGe), or the like as its main component; a semiamorphous semiconductor (hereinafter, referred to as SAS) in which an amorphous state and a crystalline state are mixed; a microcrystalline semiconductor in which a crystal grain of 0.5 to 20 nm; and a semiconductor having a crystalline structure (polycrystalline semiconductor) can be observed in an amorphous semiconductor can be used for the first semiconductor film 108. Note that a microcrystalline state in which a crystal grain of 0.5 to 20 nm can be observed is referred to as a so-called microcrystal (hereinafter, referred to as μc). An acceptor type element such as phosphorus, arsenic, or boron, or a donor type element may be contained in addition to the above main component. The thickness of the first semiconductor film 108 is 10 to 150, and more preferably, 30 to 70 nm.

An insulator 109 is formed at a position which is over the first semiconductor film 108 and is overlapped with the gate electrode 106 which is formed before forming the insulator 109. The insulator 109 is formed with a single layer or a stacked layer using a silicon oxide film, silicon nitride film, a silicon oxynitrirde film, a silicon nitride oxide film, or other insulating films containing silicon. The thickness of the insulator 109 is formed so as to be thicker than that of a source region 110, a drain region 111, a source electrode 112, and a drain electrode 113. Specifically, the thickness is preferably 500 nm or more. Furthermore, the width of the insulator 109 (L₂ shown in FIG. 1) is formed so as to be narrower than that of the gate electrode 106 (L₁ shown in FIG. 1). By controlling the width of the insulator 109 (L₂ shown in FIG. 1), the width of a light-shielding body 114 can be controlled. In other words, by setting the width of the light-shielding body 114 to be narrower than that of the gate electrode 106 (L₁ shown in FIG. 1), parasitic capacitance due to providing the light-shielding body 114 can be reduced.

Then, the source region 110 and the drain region 111, the source electrode 112 formed over the source region 110, the drain electrode 113 formed over the drain region 111, and the light-shielding body 114 formed the insulator 109, respectively.

The source region 110 and the drain region 111 are formed using a semiconductor film of an amorphous semiconductor containing silicon, silicon germanium (SiGe), or the like as its main component; a SAS; a μc; or the like. The semiconductor film herein used contains an acceptor type element such as phosphorus, arsenic, or boron, or a donor type element in addition to the above main component. Also, the thickness of each of the source region 110 and the drain region 111 is preferably 10 to 150 nm, and more preferably, 30 to 70 nm.

As a material used for the source electrode 112, the drain electrode 113, and the light-shielding body 114, a film such as a film made of a metal element such as Ag, Au, Cu, Ni, Pt, Pd, Ir, Rh, W, Al, Ta, Mo, Cd, Zn, Fe, Ti, Zr, or Ba; a film made of an alloy material containing the above-described element as its main component; a film made of an alloy material containing an element such as Si or Ge; a film made of a compound material such as metal nitride; a film of indium tin oxide (ITO) which is used as a transparent conductive film, IZO (indium zinc oxide) in which 2 to 20% of zinc oxide (ZnO) is mixed into indium oxide, ITO having silicon oxide as a composition, or the like can be used. In addition, the thickness of each of the source electrode 112, the drain electrode 113, and the light-shielding body 114 is preferably 200 nm or more, and more preferably, 300 to 500 nm.

In a case of the liquid crystal display panel shown in Embodiment Mode 1, a light source can be provided at either side of both sides of the liquid crystal display panel (the substrate 101 side or a substrate 118 side in FIG. 1). However, since the TFT 105 is a bottom gate TFT, part of the first semiconductor film 108 (a channel formation region of the TFT 105) is irradiated with light in a case of a structure in which a light source is provided at the substrate 118 side and light is emitted from the light source in the direction indicated by an arrow in FIG. 1. When an active layer (the channel formation region) of the TFT 105 is irradiated with light as described above, an effect on electrical characteristics such as a leak current which occurs between the source region and the drain region becomes a problem in a case of driving the TFT 105. However, providing the light-shielding body 114 makes it possible to prevent part of the first semiconductor film 108 (the so-called channel formation region of the TFT 105) from being irradiated with light.

An insulating film functioning as a protection film 115 of the TFT 105 is formed over the first semiconductor film 108, the source region 110, the drain region 111, the source electrode 112, the drain electrode 113, and the gate insulating film 107. Note that the insulating film here is formed with a single layer or a stacked layer using a silicon oxide film, a silicon nitride film, a silicon oxynitride film, a silicon nitride oxide film, or other insulating films containing silicon. Also, the thickness of the protection film 115 is 10 to 150 nm, and more preferably, 30 to 70 nm.

A pixel electrode 116 is formed, which is electrically connected to the drain electrode 113 through an opening formed at part of the protection film 115 over the drain electrode 113. The pixel electrode 116 is formed using a transparent conductive film made of a film of indium tin oxide (ITO), IZO (indium zinc oxide) in which 2 to 20% of zinc oxide (ZnO) is mixed into indium oxide, ITO having silicon oxide as a composition, or the like.

In Embodiment Mode 1, a substrate having the above structure thereover is referred to as an active matrix substrate 117.

The liquid crystal display panel in the present invention has a structure in which a liquid crystal layer is interposed between an active matrix substrate and a substrate. In other words, in Embodiment Mode 1, the liquid crystal display device has a structure in which a liquid crystal layer 119 is interposed between the active matrix substrate 117 and the substrate 118. A known liquid crystal material can be used for the liquid crystal layer 119.

In addition, alignment films 120 and 121 are formed over the surfaces of the active matrix substrate 117 and the substrate 118, respectively. The alignment films 120 and 121 are formed using a material such as polyimide or polyamide. Alignment treatment for aligning the liquid crystal is performed to the alignment films 120 and 121. Note that the substrate which can be used for the substrate 101 can be used for the substrate 118 in the same manner.

As described above, the liquid crystal display panel explained in Embodiment Mode 1 has a structure in which the active matrix substrate in which the light-shielding film 102, the coloring film 103, the TFT 105, the pixel electrode 116, other wirings, and the like are all formed over the substrate 101 and the substrate over which only the alignment film is formed are attached to each other and the liquid crystal layer is formed therebetween; accordingly, a position alignment which is necessary in attaching substrates is unnecessary differently from a case of forming the light-shielding film or the coloring film over the substrate 118 at the opposite side.

In a liquid crystal display device formed using the liquid crystal display panel shown in Embodiment Mode 1, an In-Plane Switching driving mode such as an IPS mode or an FSS mode is used in view of structural characteristics thereof; therefore, the light-shielding film 102 is preferably formed not using a conductive material but using a resin material in order to prevent an electric field which disturbs an in-plane switching formed between the pixel electrode 116 and the common electrode 122 in the active matrix substrate from being generated.

### Embodiment Mode 2

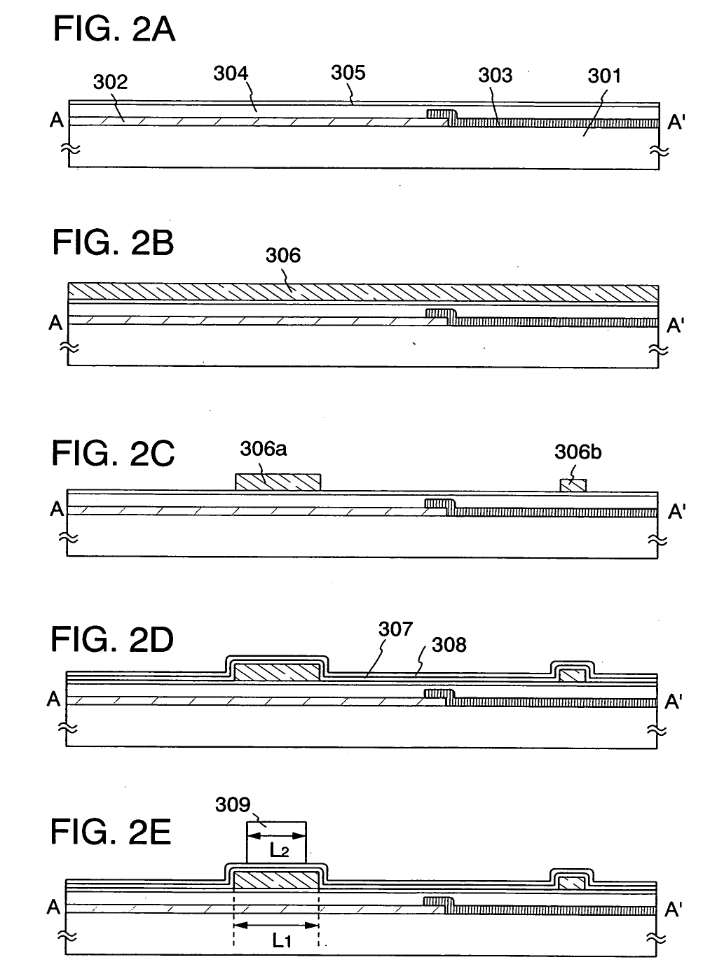

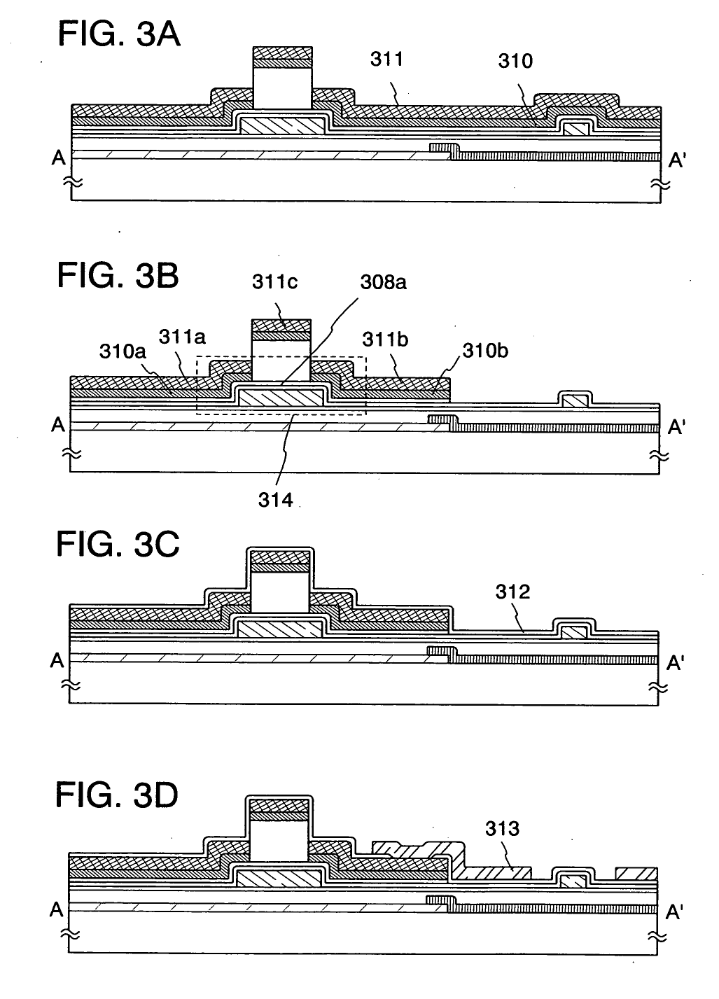

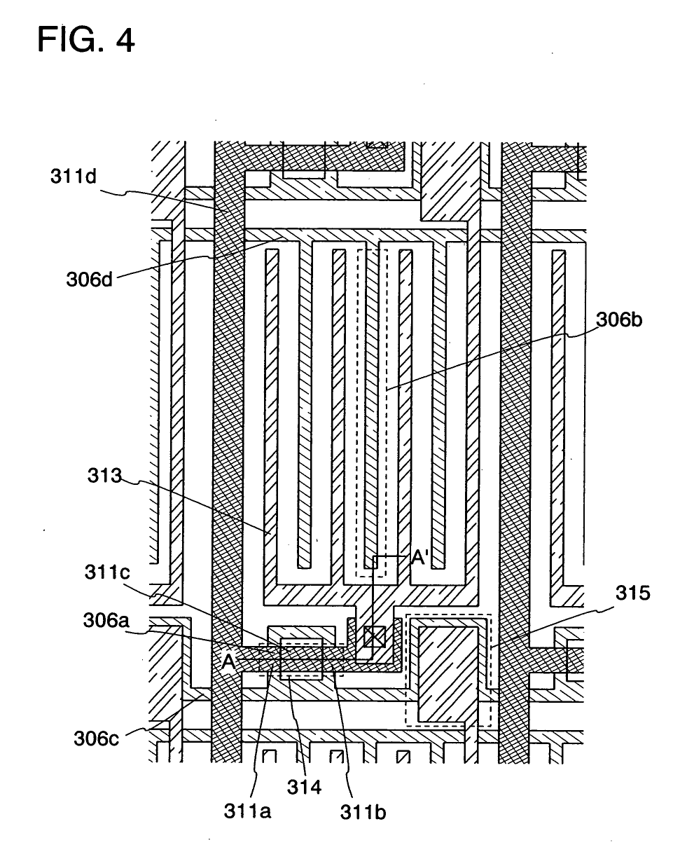

In Embodiment Mode 2, a method for manufacturing an active matrix substrate included in the liquid crystal display panel explained in Embodiment Mode 1 will be explained with reference to FIGS. 2A to 2E, FIGS. 3A to 3D, and FIG. 4. Note that FIG. 4 is a plan view of an active matrix substrate, and FIGS. 2A to 2E and FIGS. 3A to 3D are cross-sectional views taken along line A-A′ in FIG. 4. Also, same reference numerals are used in FIGS. 2A to 2E, FIGS. 3A to 3D, and FIG. 4.

First, as shown in FIG. 2A, a light-shielding film 302 is formed over a substrate 301.

As the substrate 301, a glass substrate, a quartz substrate, a substrate made of an insulating substance such as ceramic such as alumina, a plastic substrate, a silicon wafer, a metal plate, or the like can be used. In addition, a large-sized substrate having a size of 320×400 mm, 370×470 mm, 550×650 mm, 600×720 mm, 680×880 mm, 1000×1200 mm, 1100×1250 mm, or 1150×1300 mm can be used.

Note that as a representative example of a plastic substrate, a plastic substrate made of PET (polyethylene terephthalate), PEN (polyethylene naphthalate), PES (polyether sulfone), polypropylene, polypropylene sulfide, polycarbonate, polyetherimide, polyphenylene sulfide, polyphenylene oxide, polysulfone, or polyphthalamide; a substrate formed from an organic material in which inorganic particles having a diameter of several nm are dispersed; or the like can be given. Also, a surface of the substrate may not necessarily be flat, and a surface having concavity and convexity or a rounded surface may also be used.

The light-shielding film 302 is patterned to be formed so as to cover all of the periphery of each pixel in a pixel portion or part thereof. The light-shielding film 302 is formed using a metal material such as chromium or chromium oxide in addition to an insulating film (such as polyimide or an acrylic resin) containing a color pigment or a colorant, resin BM, carbon black, and a resist, and is formed to be 1 to 3 μm thick. Further, the light-shielding film 302 functions to prevent light of the liquid crystal display panel from leaking.

Then, a coloring film 303 is formed. The coloring film 303 is formed so that part thereof is overlapped with the light-shielding film. The coloring film 303 is formed by using a material such as a photosensitive resin or a resist in addition to an insulating film (such as polyimide or an acrylic resin) containing a color pigment. The coloring film 303 may be formed so as to show a different color (for example, three colors of red, green, and blue) every one pixel column in the pixel portion. Alternatively, the coloring film 303 may be formed so as to show a different color (for example, three colors of red, green, and blue) every one pixel. Furthermore, the coloring film 303 may be formed so that all pixels show the same color. Also, the coloring film 303 is formed to be 1 to 3 μm thick.

Subsequently, a planarizing film 304 is formed covering the light-shielding film 302 and the coloring film 303. The planarizing film 304 has a function of reducing concavity and convexity generated due to forming the light-shielding film 302 and the coloring film 303.

As a material for the planarizing film 304, acrylic acid, methacrylic acid, and a derivative thereof; a heat-resistant high molecular compound such as polyimide, aromatic polyamide, or polybenzimidazole; an inorganic siloxane polymer based insulating material including a Si—O—Si bond of compounds containing silicon, oxygen, or hydrogen formed using a siloxane polymer based material as a starting material, which is typified by silica glass; or an organic siloxane polymer based insulating material in which hydrogen bonded to silicon typified by alkylsiloxane polymer, alkylsilsesquioxane polymer, hydrogenated silsesquinoxane polymer, or hydrogenated alkylsilsesquioxane polymer is substituted by an organic group such as methyl or phenyl can be used. In addition, as a film formation method, a known method such as a coating method or a printing method can be used.

A barrier film 305 is formed over the planarizing film 304 by a CVD method. The barrier film 305 is formed with a single layer or a stacked layer using an insulating film such as a silicon nitride film, a silicon nitride oxide film, and a silicon oxynitride film by a film formation method such as a plasma CVD method or a sputtering method. By providing the barrier film 305, an impurity can be prevented from being mixed from the substrate 301 side.

As shown in FIG. 2B, a first conductive film 306 is formed over the barrier film 305. The first conductive film 306 is formed of a film made of a metal element such as Ag, Au, Cu, Ni, Pt, Pd, Ir, Rh, W, Al, Ta, Mo, Cd, Zn, Fe, Ti, Zr, Ba, or Nd; a film made of an alloy material containing the above element as its main component; a film made of an alloy material containing an element such as Si or Ge; a film made of a compound material such as metal nitride; a film of indium tin oxide (ITO) which is used as a transparent conductive film, IZO (indium zinc oxide) in which 2 to 20% of zinc oxide (ZnO) is mixed into indium oxide, ITO having silicon oxide as a composition, or the like by a film formation method such as a sputtering method, a PVD method, a CVD method, a droplet discharging method, a printing method, or an electric field plating method.

By patterning the first conductive film 306, a gate electrode 306a and a common electrode 306b are formed as shown in FIG. 2C, and a gate signal line 306c and a common wiring 306d are formed as shown in FIG. 4. In a case of forming the first conductive film 306 by using a film formation method such as a sputtering method or a CVD method, a mask is formed over the conductive film by an exposure, development, or the like of a photosensitive material using a droplet discharging method, a photolithography process, and a laser beam direct writing system, and the conductive film is patterned into a desired shape by using the mask.

In a case of using a droplet discharging method, a pattern formation can be performed without forming a mask; therefore, the gate electrode 306a, the common electrode 306b, the gate signal line 306c, the common wiring 306d, and the like are formed by discharging a liquid substance in which particles of the above-described metal are dissolved or dispersed in an organic resin from a discharge opening (hereinafter, referred to as a nozzle) and heating the liquid substance. One or more of organic resins that funtion as a binder of metal particles, a solvent, a dispersant, and a coating agent can be used for the organic resin. Typically, a known organic resin such as polyimide, an acrylic resin, a novolac resin, a melamine resin, a phenol resin, an epoxy resin, a silicon resin, a furan resin, or diallyl phthalate resin can be given.

The viscosity of the liquid substance is preferably 5 to 20 mPa·s. This is because this prevents the liquid substance from drying and enables the metal particles to be discharged smoothly from the nozzle. In addition, the surface tension of the liquid substance is preferably 40 n/N or less. Further, the viscosity and the like of the liquid substance may be appropriately adjusted in accordance with a solvent to be used and an intended purpose.

Metal particles having a grain diameter of several nm to 10 μm, which is contained in the liquid substance, can be used; however, in order to prevent the nozzle from clogging and manufacture a high definition pattern, metal particles having as small grain diameter as possible are preferable, and metal particles having a grain diameter of 0.1 μm or less is preferably used.

Next, a gate insulating film 307 is formed (FIG. 2D). The gate insulating film 307 is formed with a single layer or a stacked layer using a silicon oxide film, a silicon nitride film, a silicon oxynitride film, a silicon nitride oxide film, other insulating films containing silicon, and the like by a film formation method such as a CVD method or a sputtering method. Further, the thickness of the gate insulating film 307 is preferably 10 to 150 nm, and more preferably, 30 to 70 nm.

Subsequently, a first semiconductor film 308 is deposited. The first semiconductor film 308 is formed using a film of an amorphous semiconductor containing silicon, silicon germanium (SiGe), or the like as its main component; a SAS; a μc; or the like by a film formation method such as a CVD method or a sputtering method. An acceptor type element such as phosphorus, arsenic, or boron, or a donor type element in addition to the above-described main component may be contained in the first semiconductor film 308. Also, the thickness of the first semiconductor film 308 is 10 to 150 nm, and more preferably, 30 to 70 nm.

Then, an insulator 309 is formed at a position which is over the first semiconductor film 308 and is overlapped with the gate electrode 306a which is formed before forming the insulator 309 (FIG. 2E). By forming the insulator 309, a second semiconductor film 310 and a second conductive film 311 that are formed in the following process are separated to be formed, and each of a source region 310a, a drain region 310b, a source electrode 311a, a drain electrode 311b, and a light-shielding body 311c, each of which is included in a TFT, can be formed (FIG. 3B and FIG. 4). The insulator 309 can be formed as follows: A mask is formed over an insulating film by exposure, development, or the like of a photosensitive material using a droplet discharging method, a photolithography process, or a laser beam direct writing system, and an insulating film such as a silicon oxide film, a silicon nitride film, a silicon oxynitride film, a silicon nitride oxide film, other insulating films containing silicon (the insulating film may be any of a single layer or stacked layer structure) is patterned into a desired shape by using the mask. The insulator 309 is formed so that the thickness of the insulator 309 is thicker than that of the source electrode 311a and the drain electrode 311b. Specifically, the thickness is 200 nm, more preferably, 300 to 800 nm. Furthermore, the insulator 309 is formed so that the width of the insulator 309 (L₂ shown in FIG. 2E) is narrower than that of the gate electrode 306a (L₁ shown in FIG. 2E).

Next, the second semiconductor film 310 which shows one conductivity type is formed (FIG. 3A). The second semiconductor film 310 is formed by a film formation method such as a CVD method or a sputtering method. A film of an amorphous semiconductor containing silicon, silicon germanium (SiGe), or the like as its main component; a SAS; a μc; or the like which is herein formed contains an acceptor type element such as phosphorus, arsenic, or boron, or a donor type element in addition to the above main component. Further, the second semiconductor film 310 is separated into a portion which is formed over the insulator 309 and a portion which is formed over the first semiconductor film 308. Note that, at this time, in a case where a part of the second semiconductor film 310 is formed at the side face of the insulator 309, etching treatment or the like may be performed.

Furthermore, the second conductive film 311 is formed over the second semiconductor film 310. Note that the second conductive film 311 can be formed by the similar method and using the similar material to the first conductive film 306 which has been described earlier in this embodiment mode. The thickness of the second conductive film 311 is preferably 200 nm or more, and more preferably, 300 to 700 nm. The second conductive film 311 is separated by the insulator 309 to be formed in the same manner as the second semiconductor film 310. Note that, at this time, in a case where a part of the second conductive film 311 is formed at the side face of the insulator 309, etching treatment or the like may be performed.

Next, the second conductive film 311 is patterned to form the source electrode 311a and the drain electrode 311b (FIG. 3B and FIG. 4), and furthermore, the first semiconductor film 308 and the second semiconductor film 310 are etched using the source electrode 311a and the drain electrode 311b as a mask to obtain a shape shown in FIG. 3B. In other words, each of the source region 310a, the drain region 310b, the source electrode 311a, the drain electrode 311b, and a channel formation region 308a (FIG. 3B and FIG. 4) is formed. In addition, the source electrode 311a is formed from a film continued from a source signal line 311d as shown in FIG. 4. An etching method can be used for patterning into a desired shape by using a mask which is formed over the second conductive film 311 by exposure, development, or the like of a photosensitive material using a droplet discharging method, a photolithography process, or a laser beam direct writing system.

Then, a protection film 312 is formed (FIG. 3C). The protection film 312 is formed with a single layer or a stacked layer using an insulating film such as a silicon oxide film, a silicon nitride film, a silicon nitride oxide film, and a silicon oxynitride film by a film formation method such as a plasma CVD method or a sputtering method. Note that the protection film 312 is formed also at the side face of the insulator 309; therefore, it is preferable to select a material having favorable coverage.

Subsequently, an opening is formed at the position which is part of the protection film 312 and is overlapped with the drain electrode 311b, and a pixel electrode 313 which is electrically connected to the drain electrode 311b in the opening is formed (FIG. 3D and FIG. 4). The pixel electrode 313 is formed by patterning a transparent conductive film of indium tin oxide (ITO), IZO (indium zinc oxide) in which 2 to 20% of zinc oxide (ZnO) is mixed into indium oxide, IZO having silicon oxide as a composition; or the like which is formed by a sputtering method, an evaporation method, a CVD method, a coating method, or the like. Note that the thickness of the pixel electrode 313 is preferably 100 to 150 nm.

In addition, a storage capacitor 315 is formed by forming part of the pixel electrode 313 so as to be overlapped with part of the gate signal line 306c as shown in FIG. 4. Note that reference numeral 314 denotes a TFT.

By the above process, the active matrix substrate shown in FIG. 3D and FIG. 4 can be formed.

After the active matrix substrate shown in FIG. 3D and FIG. 4 is obtained, an alignment film is formed over the active matrix substrate and a substrate which is to be a counter substrate, and these substrates are attached to each other. Thereafter, a liquid crystal material is injected between both of the substrates, and the substrates are completely sealed by a sealing member; accordingly, a liquid crystal display panel can be formed. Note that a structure of the liquid crystal display panel will be explained in detail in Embodiment Mode 6.

### Embodiment Mode 3

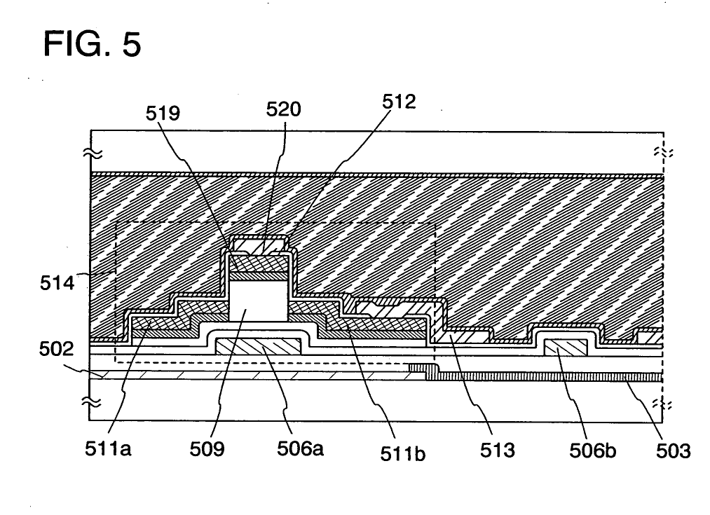

In Embodiment Mode 3, a liquid crystal display panel in which part of the structure of Embodiment Mode 1 is improved will be explained. Note that, in a liquid crystal display panel shown in FIG. 5, as for a case of denoting the similar name or the like to that in FIG. 1 explained in Embodiment Mode 1, the liquid crystal display panel can be formed by the similar material in the similar manner, and the description in Embodiment Mode 1 is referred for the detail.

A light-shielding body 519 of FIG. 5 is formed of a second conductive film which forms a source electrode 511a and a drain electrode 511b in the same manner as Embodiment Mode 1; therefore, the light-shielding body 519 is formed from a conductive material. Therefore, in a case where an insulator 509 is not formed having enough thickness, there is a case where the light-shielding body 519 becomes parasitic capacitance of a TFT 514. Thus, in Embodiment Mode 3, in order to prevent the light-shielding body 519 from becoming parasitic capacitance of the TFT 514, an auxiliary wiring 520 which is electrically connected to the light-shielding body 519 is formed.

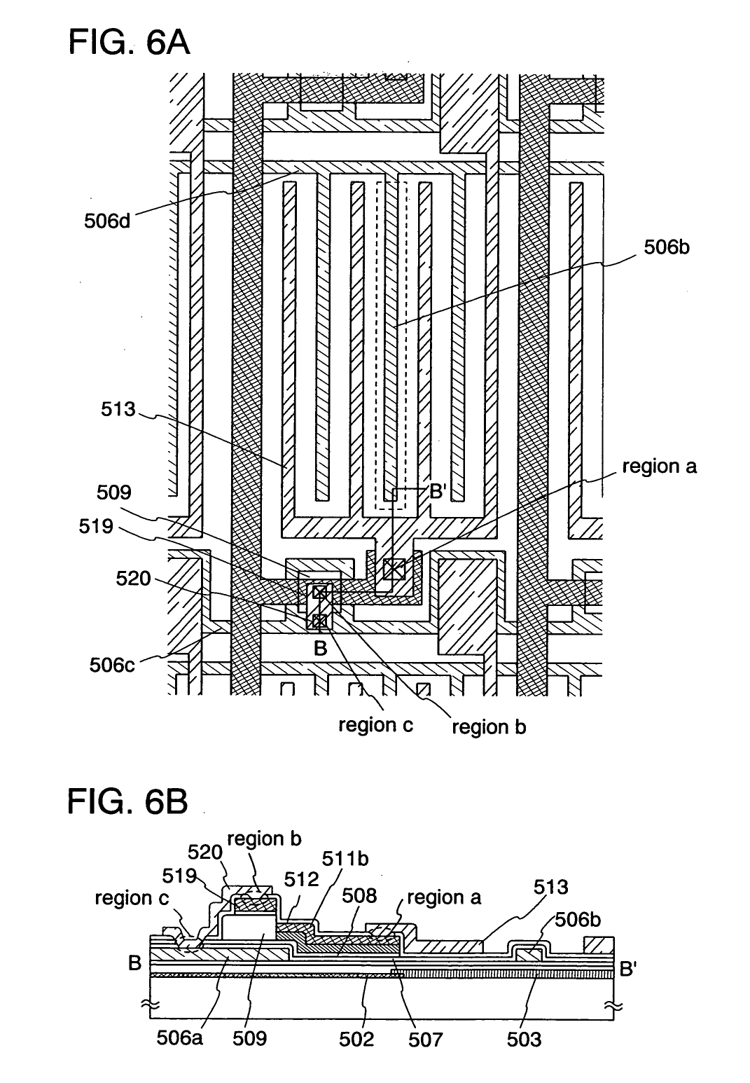

Here, FIGS. 6A and 6B are used as a plan view of an active matrix substrate included in the liquid crystal display panel of FIG. 5, and an explanation in more detail will be made. Further, a cross-sectional view taken along line B-B′ in FIG. 6A is shown in FIG. 6B. In addition, in FIGS. 6A and 6B, as for a case of denoting the similar name and the like to FIG. 4 explained in Embodiment Mode 2, the active matrix substrate can be formed by using the similar material and the similar method, and the explanation in Embodiment Mode 1 is referred for the detail.

As shown in FIG. 6A, the auxiliary wiring 520 is formed concurrently with a pixel electrode 513. That is, as shown in FIG. 6B, when an opening is formed in part of a protection film 512 (a region a shown in FIG. 6B) before forming the pixel electrode 513, an opening is formed also in part of the protection film 512 formed over the light-shielding body 519 (a region b shown in FIG. 6B) and in part of a gate insulating film 507, a first semiconductor film 508, and the protection film 512 that are stacked over a gate signal line 506c, and a transparent conductive film is patterned to form the pixel electrode 513 and the auxiliary wiring 520 concurrently. Therefore, the pixel electrode 513 and the auxiliary wiring 520 are formed in the same process and from the same conductive material.

Accordingly, the light-shielding body 519 and the gate signal line 506c are electrically connected to each other by the auxiliary wiring 520; therefore, the light-shielding body 519 can be prevented from becoming parasitic capacitance in the TFT 514. In addition, the auxiliary wiring 520 which is formed in this embodiment mode does not need a new material or a new process; therefore, the auxiliary wiring 520 can be formed without increasing the number of processes. Note that reference numeral 502 denotes a light-shielding film; reference numeral 503 denotes a coloring film; reference numeral 506a denotes a gate electrode of the TFT 514; reference numeral 506b denotes a common electrode; reference numeral 506d denotes a common wiring.

### Embodiment Mode 4

In a case where both electrodes (a pixel electrode and a common electrode) are formed in an active matrix substrate as in the present invention, a problem that an aperture ratio is decreased occurs when a conductive film having a light-shielding property is used as an electrode material. In Embodiment Mode 4, a case where not only a pixel electrode but also a common electrode is formed of a transparent conductive film will be explained.

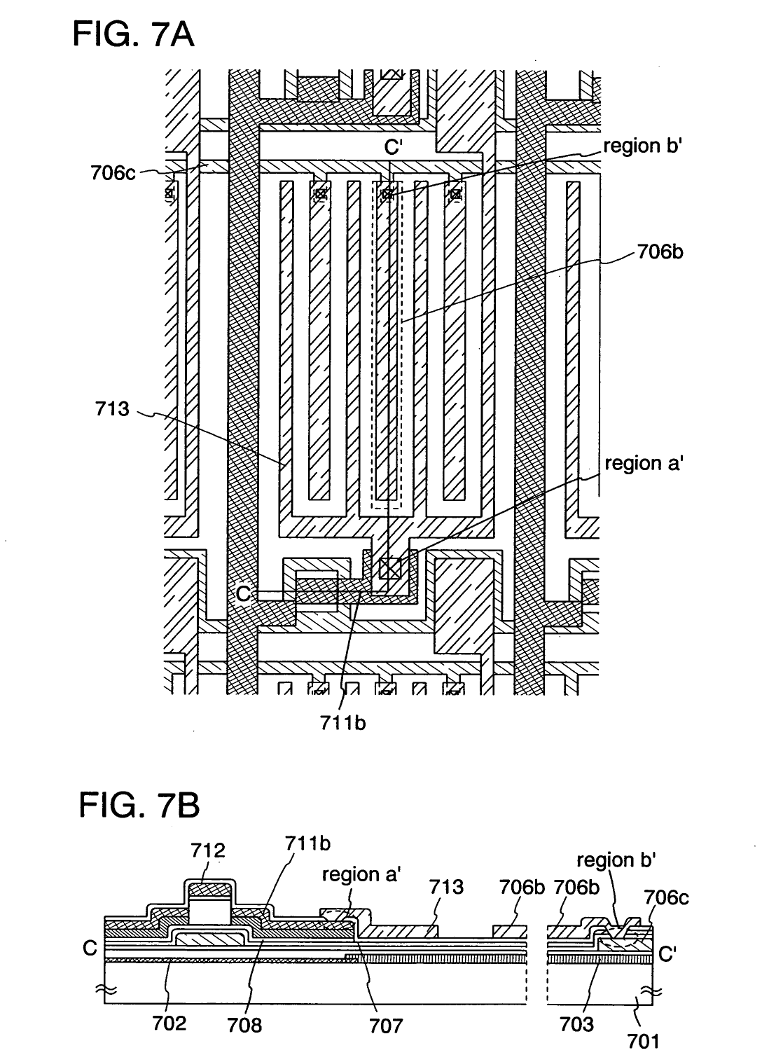

In FIGS. 7A and 7B, FIG. 7A shows a plan view of an active matrix substrate explained in Embodiment Mode 4, and FIG. 7B shows a cross-sectional view taken along line C-C′ of FIG. 7A. Note that in FIGS. 7A and 7B, as for a case of denoting the similar name and the like to FIG. 4 explained in Embodiment Mode 2, the active matrix substrate can be formed using the similar material and by the similar method, and the explanation in Embodiment Mode 2 is referred for the detail. However, a common electrode explained in Embodiment Mode 4 follows the explanation below.

As shown in FIG. 7A, a common electrode 706b is formed from the same material as a pixel electrode 713. Although the common electrode 706b is electrically connected to a common wiring 706c, the common electrode 706b is formed from a different material. That is, as shown in FIG. 7B, when an opening is formed in part of a protection film 712 (a region a′ shown in FIG. 7B) before forming the pixel electrode 713, an opening is formed also in part of the protection film 712 which is formed over the common wiring 706c (a region b′ shown in FIG. 7B), and a transparent conductive film is pattered to form the pixel electrode 713 and the common electrode 706b concurrently. Therefore, in the case of Embodiment Mode 4, the pixel electrode 713 and the common electrode 706b are formed in the same process and using the same conductive material.

Accordingly, by forming the common electrode 706b and the pixel electrode 713 using the same transparent conductive film, an aperture ratio in a pixel portion can be prevented from decreasing. In addition, the common electrode 706b does not need a new material or a new process; therefore, the common electrode 706b can be formed without increasing the number of processes. Note that reference numeral 701 denotes a substrate; reference numeral 702 denotes a light-shielding film; reference numeral 703 denotes a coloring film; reference numeral 707 denotes a gate insulating film; reference numeral 708 denotes a first semiconductor film; reference numeral 711b denotes a drain electrode.

### Embodiment Mode 5

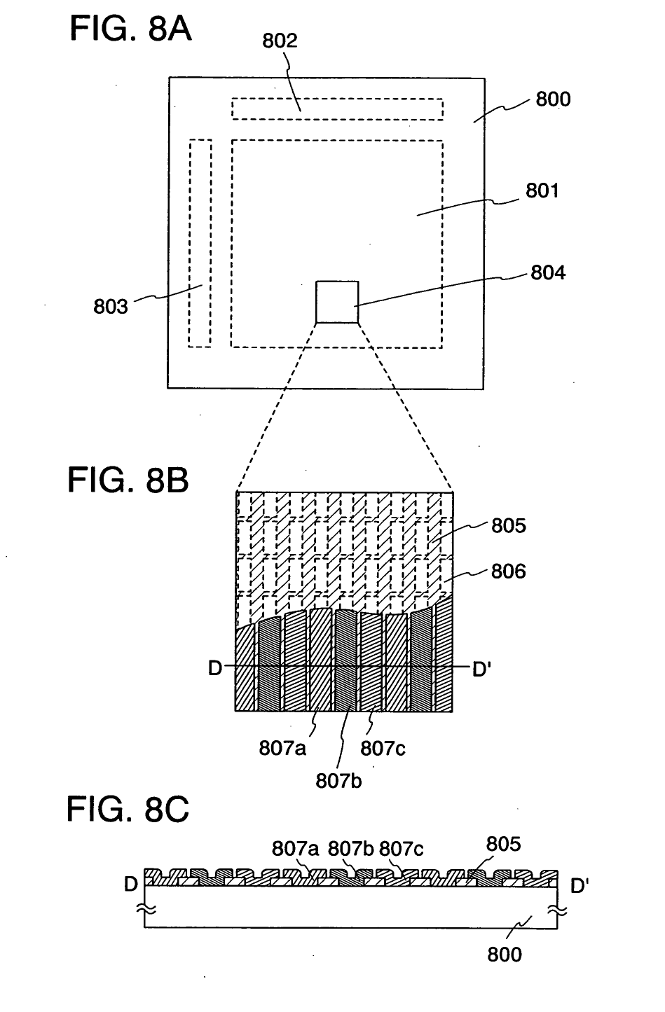

In Embodiment Mode 5, a coloring film which is formed over a substrate which is to be an active matrix substrate used in a liquid crystal display device of the present invention will be explained with reference to FIGS. 8A to 8C. Note that a structure of an active matrix substrate shown in this embodiment mode (a driver circuit, a pixel portion, and the like) is one mode of an active matrix substrate which can be used in the present invention.

FIG. 8A shows an active matrix substrate is formed by forming a driver circuit or a pixel portion in each formation region in the following process. That is, in FIG. 8A, a pixel portion is formed in a pixel portion formation region 801 over a substrate 800, a source signal line driver circuit is formed in a source signal line driver circuit formation region 802, and a gate signal line driver circuit is formed in a gate signal line driver circuit formation region 803; accordingly, an active matrix substrate is formed.

In a case of the present invention, a light-shielding film and a coloring film are formed in the pixel portion formation region 801 over the substrate 800 before these driver (the source signal line driver circuit and the gate signal line driver circuit) circuits and the pixel portion are formed.

In FIG. 8B, a view in which a region a (804) of FIG. 8A is enlarged is shown. A pixel is formed in a pixel formation region 806 of the region a (804) of FIG. 8B in the following process. Therefore, a light-shielding film 805 and a coloring film 807 are formed over the substrate 800 in advance in accordance with the pixel formation region 806.

The light-shielding film 805 is formed earlier between the pixel formation regions 806 over the substrate 800. Then, the coloring film 807 is formed covering the light-shielding film 805 and the pixel formation region 806.

Here, a case is described, where the coloring film 807 is formed of a three kinds of coloring films, that is, a coloring film R (807a) made of an insulating material containing a red pigment, a coloring film G (807b) made of an insulating material containing a green pigment, and a coloring film B (807c) made of an insulating material containing a blue pigment in a stripe form. Note that the coloring film may be of a single type (color and material) or a plurality of types. Further, the coloring film may be formed as a solid film made of a single type or as films which are differently coated. A material and a method for differently coating are not particularly limited, and the coloring film can be formed by using a known material and a known method.

In FIG. 8C, a cross-sectional view taken along line D-D′ in FIG. 8B is shown. The light-shielding film 805 is formed between the pixel formation regions 806 over the substrate 800, and the coloring film 807 (807a, 807b, and 807c) is formed between the light-shielding films 805. Further, the coloring film 807 (807a, 807b, and 807c) may be formed so as to be overlapped with the light-shielding film 805 as shown in FIG. 8C.

Although not shown here, after the light-shielding film 805 and the coloring film 807 (807a, 807b, and 807c) are formed over the substrate 800, a planarizing film is formed so that concavity and convexity over the substrate 800 are reduced. Further, the planarizing film is formed from an insulating material.

As described above, the active matrix substrate is formed by forming the driver circuit and the pixel portion over the substrate over which the light-shielding film 805, the coloring film 807 (807a, 807b, and 807c), and the planarizing film are formed. Note that as for an active matrix substrate which is formed by the following process, the descriptions in Embodiment Modes 1 to 4 are referred.

### Embodiment Mode 6

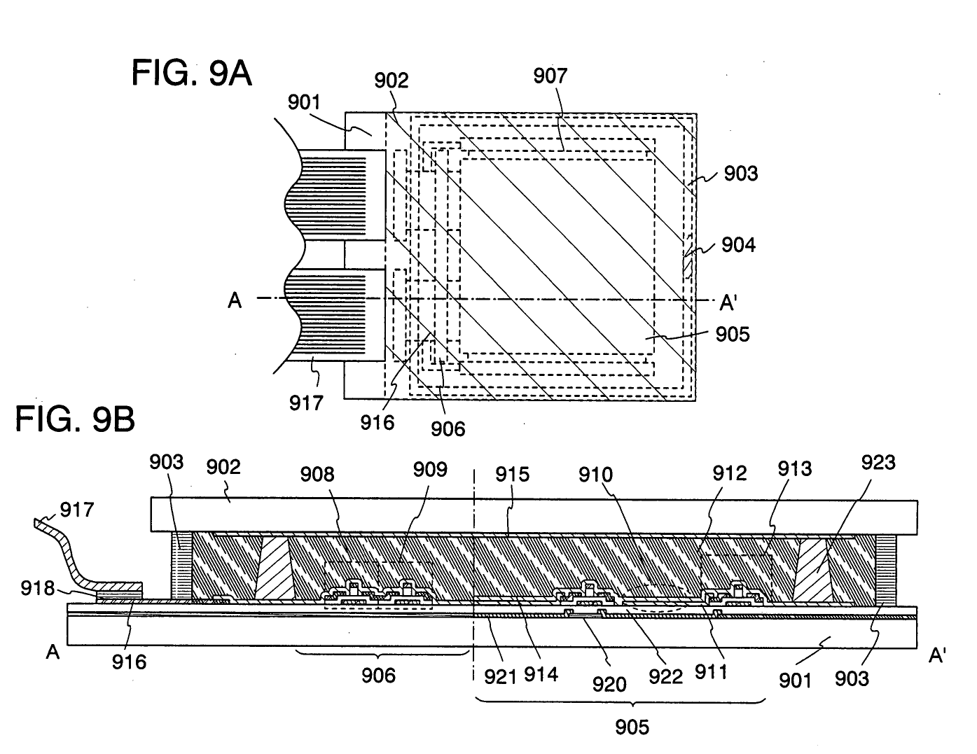

In Embodiment Mode 6, a structure of a liquid crystal display panel of the present invention will be explained with reference to FIGS. 9A and 9B. FIG. 9A is a top view showing a panel in which a first substrate 901 which is to be an active matrix substrate and a second substrate 902 which is to be a counter substrate are sealed by a first sealing material 903 and a second sealing material 904. FIG. 9B corresponds to a cross-sectional view taken along line A-A′ in FIG. 9A. In addition, the active matrix substrate explained in Embodiment Modes 1 to 4 can be used for the first substrate 901.

In FIG. 9A, reference numerals 905, 906, and 907 each shown by a dotted line denotes a pixel portion, a source signal line driver circuit, and a gate signal line driver circuit, respectively. In this embodiment mode, the pixel portion 905, the source signal line driver circuit 906, and the gate signal line driver circuit 907 are formed in a region which is sealed by the first sealing material 903 and the second sealing material 904.

A gap material for keeping an interval of an enclosed space is contained in the first sealing material 903 and the second sealing material 904 that seal the first substrate 901 and the second substrate 902, and a space formed by these is filled with a liquid crystal material.

Next, a cross-sectional structure is explained with reference to FIG. 9B. A light-shielding film 920 and a coloring film 921 are formed over the first substrate 901. A driver circuit and a pixel portion are formed over a planarizing film 922 which is formed covering the light-shielding film 920 and the coloring film 921, and a plurality of semiconductor elements typified by a TFT is included. Note that the source signal line driver circuit 906 and the pixel portion 905 are shown as the driver circuit, here. A CMOS circuit in which an n-channel TFT 908 and a p-channel TFT 909 are combined is formed in the source signal line driver circuit 906. A TFT which forms the driver circuit may be formed of a known CMOS circuit, PMOS circuit, or NMOS circuit. Although this embodiment mode shows a driver integrated type in which the driver circuit is formed over the substrate, the driver circuit may not necessarily be formed over the substrate, and the driver circuit can be formed outside, not over the substrate.

In addition, a plurality of pixels is formed in the pixel potion 905, and a liquid crystal element 910 is formed in each pixel. The liquid crystal element 910 is a portion in which a first electrode 911 which is a pixel electrode, a second electrode which is a common electrode and is not shown here, and a liquid crystal layer 912 formed from a liquid crystal material therebetween are formed. The first electrode 911 included in the liquid crystal element 910 is electrically connected to a driving TFT 913 through a wiring. Also, alignment films 914 and 915 are formed over the surface of each pixel electrode over the first substrate 901 and the surface of the second substrate 902.

Reference numeral 923 denotes a columnar spacer, which is provided to control a distance (a cell gap) between the first substrate 901 and the second substrate 902. The columnar spacer 923 is formed by etching an insulating film into a desired shape. Further, a spherical spacer may also be used.

Various signals and potential given to the source signal line driver circuit 906, the gate signal line driver circuit 907, and the pixel portion 905 are supplied from an FPC 917 through a connection wiring 916. The connection wiring 916 and the FPC 917 are electrically connected to each other by an anisotropic conductive film or an anisotropic conductive resin 918. Conductive paste such as solder may also be used instead of the anisotropic conductive film or the anisotropic conductive resin.

Although not shown, a polarizing plate is fixed to one or both of the surfaces of the first substrate 901 and the second substrate 902 by an adhesive agent. Further, a retardation film may also be provided in addition to the polarizing plate.

### Embodiment Mode 7

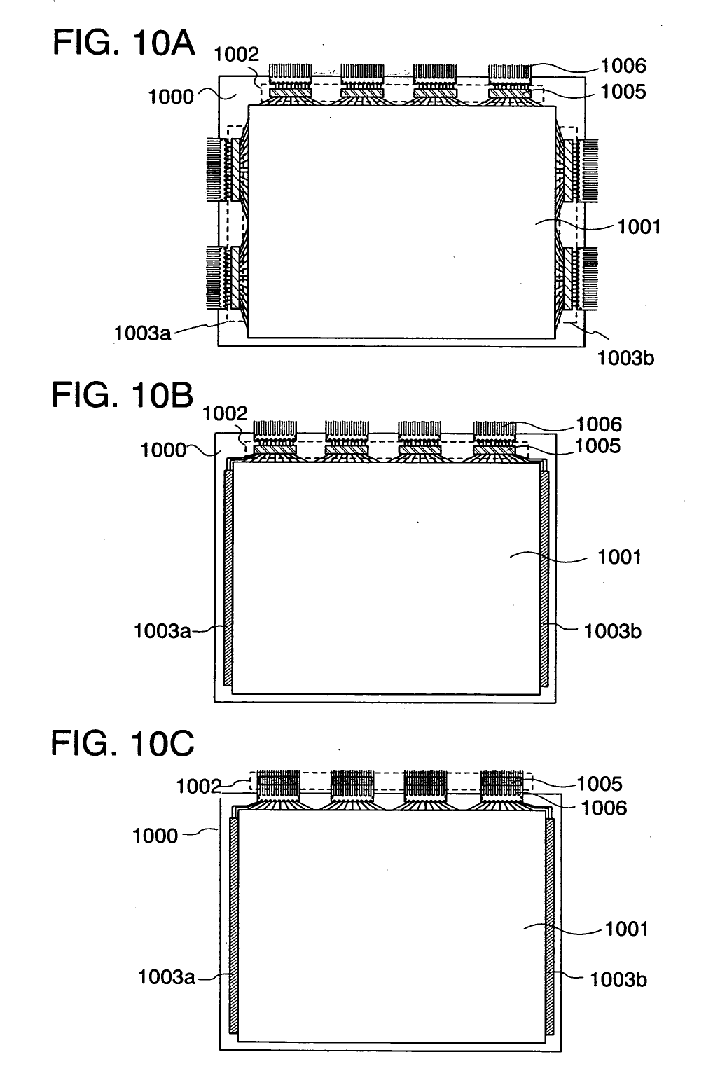

In Embodiment Mode 7, a method for mounting a driver circuit on a liquid crystal display panel of the present invention will be explained with reference to FIGS. 10A to 10C.

In a case of FIG. 10A, a source signal line driver circuit 1002 and gate signal line driver circuits 1003a and 1003b are mounted at the periphery of a pixel portion 1001. That is, the source signal line driver circuit 1002 and the gate signal line driver circuits 1003a and 1003b are mounted by mounting an IC chip 1005 on the substrate 1001 by a known mounting method using an anisotropic conductive adhesive and an anisotropic conductive film, a COG method, a wire bonding method, reflow treatment using a solder bump, or the like. Further, the IC chip 1005 is connected to an external circuit through an FPC (flexible print circuit) 1006.

Part of the source signal line driver circuit 1002, for example, an analog switch may be integrated over the substrate and the other portion thereof may be mounted by the IC chip separately.

In addition, in a case of FIG. 10B, the pixel portion 1001, the gate signal line driver circuits 1003a and 1003b, and the like are integrated over the substrate, and the source signal line driver circuit 1002 and the like are separately mounted by the IC chip. That is, the IC chip 1005 is mounted on the substrate over which the pixel portion 1001, the gate signal line driver circuits 1003a and 1003b, and the like are integrated by a mounting method such as a COG method; accordingly, the source signal line driver circuit 1002 and the like are mounted. Further, the IC chip 1005 is connected to an external circuit through the FPC 1006.

Part of the source signal line driver circuit 1002, for example, an analog switch may be integrated over the substrate and the other portion thereof may be mounted by the IC chip separately.

Moreover, in a case of FIG. 10C, the source signal line driver circuit 1002 and the like are mounted by a TAB method. The IC chip 1005 is connected to an external circuit through the FPC 1006. Although the source signal line driver circuit 1002 and the like are mounted by a TAB method in a case of FIG. 10C, the gate signal line driver circuit and the like may be mounted by a TAB method. Note that reference numeral 1000 denotes a substrate.

When the IC chip 1005 is mounted by a TAB method, a pixel portion can be provided widely with respect to the substrate, and accordingly, a narrowed frame can be achieved.

In addition, an IC in which an IC is formed over a glass substrate (hereinafter, referred to as a driver IC) may be provided instead of the IC chip 1005. As for the IC chip 1005, an IC chip is taken out of a circular silicon wafer; therefore, the shape of a mother substrate is limited. On the other hand, the driver IC has a mother substrate made of glass and the shape is not limited; thus, the productivity can be improved. Therefore, the shape and the size of the driver IC can be set freely. For example, in a case of forming the driver IC having a long side length of 15 to 80 mm, the required number of the IC chips can be reduced as compared with a case of mounting IC chips. Accordingly, the number of connection terminals can be reduced, and the yield in a manufacturing can be improved.

A driver IC can be formed using a crystalline semiconductor formed over a substrate, and the crystalline semiconductor may be formed by being irradiated with continuous wave laser light. A semiconductor film obtained by being irradiated with continuous wave laser light has crystal grains having large diameter with less crystal defects. Accordingly, a transistor having such a semiconductor film has favorable mobility and response speed and becomes capable of high speed drive, which is preferable for a driver IC.

### Embodiment Mode 8

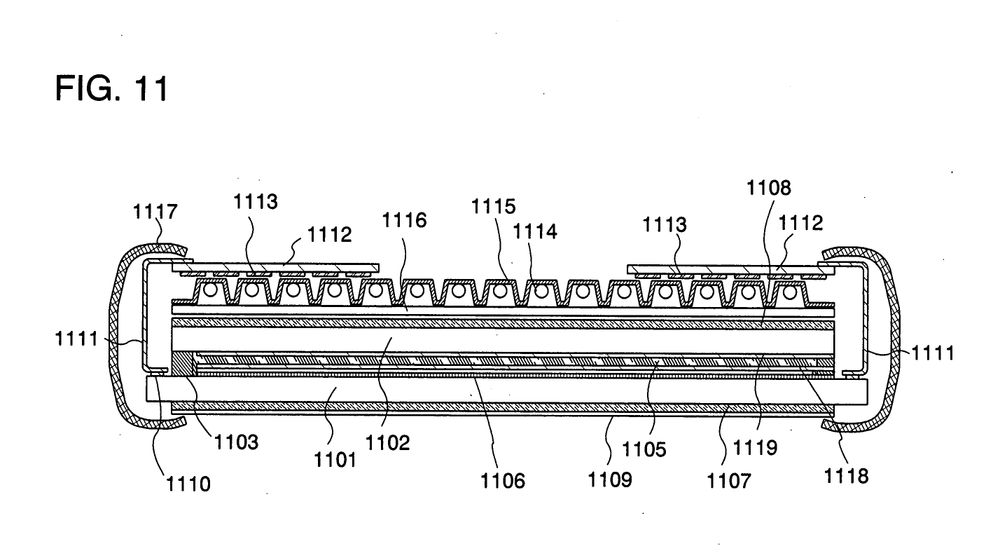

In Embodiment Mode 8, a liquid crystal module performing color display by using white light of a driving mode such as an IPS (In-Plane-Switching) mode or a Fringe Field Switching (FFS) mode, which is a liquid crystal module incorporated into a liquid crystal display device of the present invention will be explained with reference to a cross-sectional view of FIG. 11. Note that the liquid crystal display panel formed by carrying out Embodiment Modes 1 to 7 can be used for a liquid crystal module explained in Embodiment Mode 8.

As shown in FIG. 11, an active matrix substrate 1101 and a counter substrate 1102 are fixed to each other by a sealing material 1103, and a liquid crystal layer 1105 is provided therebetween; accordingly, a liquid crystal display panel is formed.

A coloring film 1106 formed in the active matrix substrate 1101 is necessary in a case of performing color display, and in a case of an RGB system, a coloring film corresponding to each color of red, green, and blue is formed in each pixel. Alignment films 1118 and 1119 are formed inside of the active matrix substrate 1101 and the counter substrate 1102. Polarizing plates 1107 and 1108 are located outside of the active matrix substrate 1101 and the counter substrate 1102. In addition, a protection film 1109 is formed over the surface of the polarizing plate 1107, and external impact is eased.

A wiring substrate 1112 is connected to a connection terminal 1110 provided over the active matrix substrate 1101 through an FPC 1111. An external circuit 1113 such as a pixel driver circuit (such as an IC chip or a driver IC), a control circuit, or a power source circuit is incorporated into the wiring substrate 1112.

A cold-cathode tube 1114, a reflecting plate 1115, an optical film 1116, and an inverter (not shown) constitute a backlight unit. With the backlight unit as a light source, light is projected toward the liquid crystal display panel. The liquid crystal display panel, the light source, the wiring substrate 1112, the FPC 1111, and the like are maintained and protected by a bezel 1117.

### Embodiment Mode 9

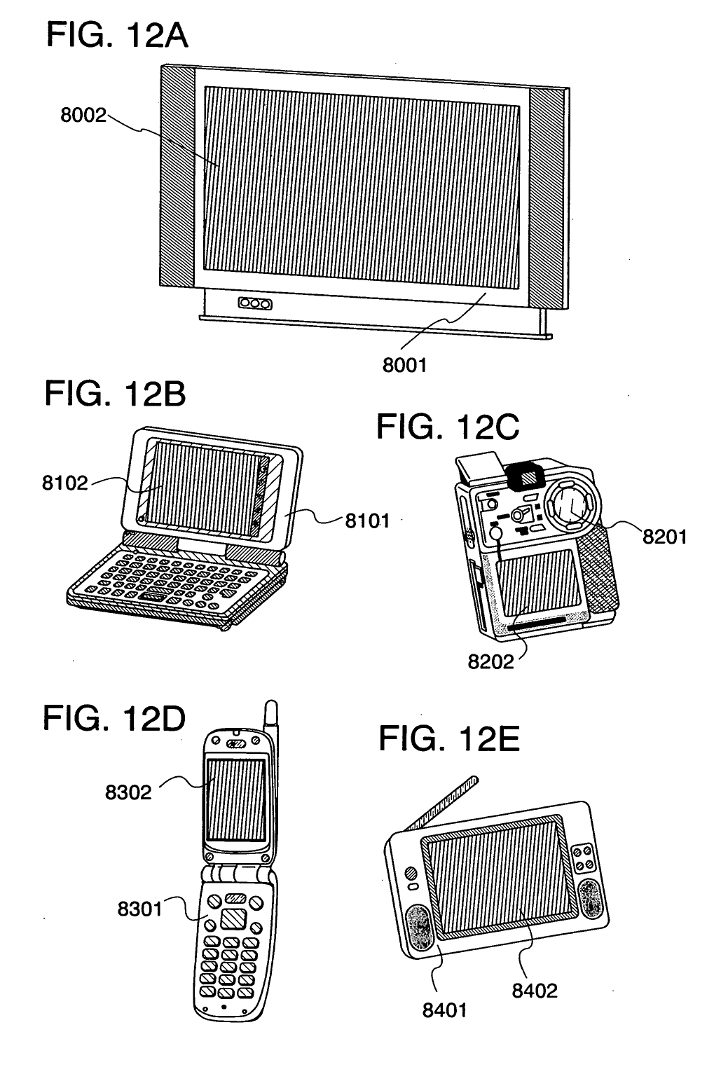

As electronic devices equipped with the liquid crystal display device of the present invention, the following can be given: a television device (also simply referred to as a TV or a TV receiver), a camera such as digital camera or a digital video camera, a cellular phone device (also simply referred to as a cellular phone handset or a cellular phone), a portable information terminal such as PDA, a portable game machine, a computer monitor, a computer, an audio reproducing device such as a car audio, an image reproducing device provided with a recording medium such as a home game machine, and the like. The preferable mode thereof will be explained with reference to FIGS. 12A to 12E.

A television device shown in FIG. 12A includes a main body 8001, a display portion 8002, and the like. The liquid crystal display device of the present invention can be applied to the display portion 8002. A coloring film is formed on an active matrix substrate in the liquid crystal display device of the present invention; therefore, misalignment of the position which becomes a problem in attaching the active matrix substrate and a counter substrate can be prevented, and a shift or a blur in an image can be prevented. Accordingly, a television device capable of realizing excellent image display can be provided.

A portable information terminal device shown in FIG. 12B includes a main body 8101, a display portion 8102, and the like. The liquid crystal display device of the present invention can be applied to the display portion 8102. A coloring film is formed on an active matrix substrate in the liquid crystal display device of the present invention; therefore, misalignment of the position which becomes a problem in attaching the active matrix substrate and a counter substrate can be prevented, and a shift or a blur in an image can be prevented. Accordingly, a portable information terminal device capable of realizing excellent image display can be provided.

A digital video camera shown in FIG. 12C includes a main body 8201, a display portion 8202, and the like. The liquid crystal display device of the present invention can be applied to the display portion 8202. A coloring film is formed on an active matrix substrate in the liquid crystal display device of the present invention; therefore, misalignment of the position which becomes a problem in attaching the active matrix substrate and a counter substrate can be prevented, and a shift or a blur in an image can be prevented. Accordingly, a digital video camera capable of realizing excellent image display can be provided.

A cellular phone handset shown in FIG. 12D includes a main body 8301, a display portion 8302, and the like. The liquid crystal display device of the present invention can be applied to the display portion 8302. A coloring film is formed on an active matrix substrate in the liquid crystal display device of the present invention; therefore, misalignment of the position which becomes a problem in attaching the active matrix substrate and a counter substrate can be prevented, and a shift or a blur in an image can be prevented. Accordingly, a cellular phone handset capable of realizing excellent image display can be provided.

A portable television device shown in FIG. 12E includes a main body 8401, a display portion 8402, and the like. The liquid crystal display device of the present invention can be applied to the display portion 8402. A coloring film is formed on an active matrix substrate in the liquid crystal display device of the present invention; therefore, misalignment of the position which becomes a problem in attaching the active matrix substrate and a counter substrate can be prevented, and a shift or a blur in an image can be prevented. Accordingly, a portable television device capable of realizing excellent image display can be provided. In addition, the liquid crystal display device of the present invention can be widely applied to various television devices such as a small sized one incorporated in a portable terminal, a medium sized one which is portable, and a large sized one (for example, 40 inches or more in size).

As described above, by using the liquid crystal display device of the present invention which can prevent a shift or a blur in an image, electronic devices capable of realizing excellent image display can be provided.

This application is based on Japanese Patent Application serial No. 2005-191078 filed in Japan Patent Office on Jun. 30, 2005, the entire contents of which are hereby incorporated by reference.

What is claimed is:

1. A display device comprising:
a light-shielding film and a coloring film formed over a substrate;
an insulating film formed over the light-shielding film and the coloring film;
a thin film transistor formed over the insulating film; and
a pixel electrode electrically connected to the thin film transistor.

2. A display device comprising:
a light-shielding film and a coloring film formed over a substrate;
an insulating film formed over the light-shielding film and the coloring film; and
a thin film transistor, a pixel electrode, and a common electrode formed over the insulating film,
wherein the thin film transistor is electrically connected to the pixel electrode.

3. The display device according to claim 1, wherein the coloring film covers an end of the light-shielding film.

4. The display device according to claim 2, wherein the coloring film covers an end of the light-shielding film.

5. The display device according to claim 1, wherein the light-shielding film comprises a metal material, an insulating film containing a color pigment or a colorant, resin BM, carbon black, or a resist.

6. The display device according to claim 2, wherein the light-shielding film comprises a metal material, an insulating film containing a color pigment or a colorant, resin BM, carbon black, or a resist.

7. The display device according to claim 1, wherein the coloring film comprises a photosensitive resin, a resist, or an insulating film containing a color pigment

8. The display device according to claim 2, wherein the coloring film comprises a photosensitive resin, a resist, or an insulating film containing a color pigment

9. The display device according to claim 1, wherein the display device is a liquid crystal display device.

10. The display device according to claim 2, wherein the display device is a liquid crystal display device.

11. The display device according to claim 1, wherein the pixel electrode is overlapped with the coloring film.

12. The display device according to claim 2, wherein the pixel electrode and the common electrode are overlapped with the coloring film.

13. The display device according to claim 1, wherein the thin film transistor comprises a gate electrode, a gate insulating film, a semiconductor film, a source electrode, and a drain electrode.

14. The display device according to claim 2, wherein the thin film transistor comprises a gate electrode, a gate insulating film, a semiconductor film, a source electrode, and a drain electrode.

15. The display device according to claim 13, wherein the semiconductor film is formed of a semiconductor selected from the group consisting of an amorphous semiconductor containing silicon or silicon germanium as its main component, a semiamorphous semiconductor in which an amorphous state and a crystalline state are mixed, and a semiconductor having a crystalline structure.

16. The display device according to claim 14, wherein the semiconductor film is formed of a semiconductor selected from the group consisting of an amorphous semiconductor containing silicon or silicon germanium as its main component, a semiamorphous semiconductor in which an amorphous state and a crystalline state are mixed, and a semiconductor having a crystalline structure.

17. The display device according to claim 13, further comprising:
an insulator formed over the semiconductor film and overlapped with the gate electrode.

18. The display device according to claim 14, further comprising:
an insulator formed over the semiconductor film and overlapped with the gate electrode.

19. The display device according to claim 17, wherein thickness of the insulator is thicker than that of each of the source electrode and the drain electrode.

20. The display device according to claim 18, wherein thickness of the insulator is thicker than that of each of the source electrode and the drain electrode.

21. The display device according to claim 17, wherein a light-shielding body is formed over the insulator.

22. The display device according to claim 18, wherein a light-shielding body is formed over the insulator.

23. The display device according to claim 21, wherein the light-shielding body is electrically connected to the gate electrode through an auxiliary wiring.

24. The display device according to claim 22, wherein the light-shielding body is electrically connected to the gate electrode through an auxiliary wiring.

25. The display device according to claim 23, wherein the auxiliary wiring is formed from the same material as the pixel electrode.

26. The display device according to claim 24, wherein the auxiliary wiring is formed from the same material as the pixel electrode.

27. A method for manufacturing a display device comprising the steps of:
forming a light-shielding film and a coloring film over a substrate;
forming an insulating film over the light-shielding film and the coloring film;
forming a gate electrode over the insulating film;
forming a gate insulating film over the gate electrode;
forming a first semiconductor film over the gate insulating film;
forming an insulator over the first semiconductor film;
forming a second semiconductor film separated by the insulator over the first semiconductor film;
forming a source electrode and a drain electrode separated by the insulator over the second semiconductor film; and
forming a pixel electrode electrically connected to at lease one of the source electrode and the drain electrode.

28. A method for manufacturing a display device comprising the steps of:
forming a light-shielding film and a coloring film over a substrate;
forming an insulating film over the light-shielding film and the coloring film;
forming a gate electrode and a common electrode over the insulating film;
forming a gate insulating film over the gate electrode and the common electrode;
forming a first semiconductor film over the gate insulating film;
forming an insulator over the first semiconductor film;
forming a second semiconductor film separated by the insulator over the first semiconductor film;
forming a source electrode, a drain electrode, and a light-shielding body separated by the insulator over the second semiconductor film; and
forming a pixel electrode electrically connected to at lease one of the source electrode and the drain electrode.

29. The method for manufacturing a display device according to claim 27, wherein the coloring film covers an end of the light-shielding film.

30. The method for manufacturing a display device according to claim 28, wherein the coloring film covers an end of the light-shielding film.

31. The method for manufacturing a display device according to claim 27, wherein the light-shielding film comprises a metal material, an insulating film containing a color pigment or a colorant, resin BM, carbon black, or a resist.

32. The method for manufacturing a display device according to claim 28, wherein the light-shielding film comprises a metal material, an insulating film containing a color pigment or a colorant, resin BM, carbon black, or a resist.

33. The method for manufacturing a display device according to claim 27, wherein the coloring film comprises a photosensitive resin, a resist, or an insulating film containing a color pigment

34. The method for manufacturing a display device according to claim 28, wherein the coloring film comprises a photosensitive resin, a resist, or an insulating film containing a color pigment

35. The method for manufacturing a display device according to claim 27, wherein the display device is a liquid crystal display device.

36. The method for manufacturing a display device according to claim 28, wherein the display device is a liquid crystal display device.

37. The method for manufacturing a display device according to claim 27, wherein the pixel electrode is overlapped with the coloring film.

38. The method for manufacturing a display device according to claim 28, wherein the pixel electrode is overlapped with the coloring film.

39. The method for manufacturing a display device according to claim 27, wherein the first semiconductor film is formed of a semiconductor selected from the group consisting of an amorphous semiconductor containing silicon or silicon germanium as its main component, a semiamorphous semiconductor in which an amorphous state and a crystalline state are mixed, and a semiconductor having a crystalline structure.

40. The method for manufacturing a display device according to claim 28, wherein the first semiconductor film is formed of a semiconductor selected from the group consisting of an amorphous semiconductor containing silicon or silicon germanium as its main component, a semiamorphous semiconductor in which an amorphous state and a crystalline state are mixed, and a semiconductor having a crystalline structure.

41. The method for manufacturing a display device according to claim 27, wherein the pixel electrode comprises a transparent conductive film.

42. The method for manufacturing a display device according to claim 28, wherein the pixel electrode comprises a transparent conductive film.
